(19) United States
(12) Patent Application Publication
(10) Pub. No.: US 2006/0054421 A1
(43) Pub. Date: Mar. 16, 2006

(54) Elevator operating panel

(75) Inventor: Kyoichi Ikeda, Tokyo (JP)

Correspondence Address: FOLEY AND LARDNER LLP;SUITE 500, 3000 K STREET NW, WASHINGTON, DC, 20007, US

(73) Assignee: Toshiba Elevator Kabushiki Kaisha

(21) Appl. No.: 10/536,826

(22) PCT Filed: Nov. 27, 2003
(86) PCT No.: PCT/JP03/15160

§ 371 Date: Jul. 6, 2005

(30) Foreign Application Priority Data
Nov. 29, 2002 (JP) 2002-348963

(51) Int. Cl. B66B 1/50

(52) U.S. Cl. 187/395

(57) ABSTRACT

A faceplate (4) has a dual structure comprising a base member (5) and a dressing member (6), and a surface of the base member (5) is covered by the dressing member (6). All of devices that are necessary for a hall operating panel (1), such as switches (10a, 10b) operated by a passenger, are fixed to and supported by the base member (5). The dressing member (6) is removably attached to the base member to thereby be easily removed from the base member (5).

### TECHNICAL FIELD

The present invention relates to an elevator operating panel which is installed at a given position in an elevator hall (a platform), or within a cab (an elevator car) of an elevator, to be used for performing operations such as a hall call or a cab call.

### BACKGROUND ART

At an elevator hall or within a cab of an elevator, there is installed an elevator operating panel for permitting a passenger to perform an operation such as a hall call or a cab call. A conventional elevator operating panel is integrally assembled with an accommodation box and a faceplate, and the faceplate is configured to close an opening portion of the accommodation box (refer to, for example, a Japanese Patent Application Laid-Open No. H5-147873 (first related material) and a Japanese Patent Application Laid-Open No. H11-60116 (second related material).

According to the conventional elevator operating panels being disclosed in first and second related materials, various kinds of devices, such as switches operated by a passenger, are necessary for the elevator operating panel, and the various devices are attached to the reverse-surface side of the faceplate in a state where they can be operated from the obverse-surface side of the faceplate. Those various kinds of devices attached to the reverse-surface side of the faceplate are accommodated within the space in the accommodation box so as to close the opening portion of the accommodation box.

By the way, an elevator is frequently utilized by a non-specified and large number of passengers, and therefore, there are cases where the obverse-surface side of the faceplate of the elevator operating panel is inconveniently clawed or damaged by passengers' mischief, or the like. Although, in those cases, it is desirable to replace the damaged faceplate with a new one In this occasion, however, in the conventional elevator operating panel having the above-described structure, there is the problem that the replacing operation for replacing the faceplate with new one is very complicated and troublesome.

Namely, in a case where replacing the faceplate in the conventional elevator operating panel, detaching various kinds of devices such as the switch devices operated by passengers from the faceplate and newly attaching those devices to a new faceplate is needed. At this time, if the switch devices, etc. do not attached correctly, the switch devices do not work. Hence, above-replacing operation of the switch devices requires a high accuracy. For this reason, in the conventional elevator operating panel of the conventional structure, the faceplate-replacing operation needs to be carefully performed, over a long period of time, by an engineer whose skill is high in level, and, therefore, this operation was complex and troublesome.

Also, the faceplate of the elevator operating panel has a function to make good the appearance of the elevator operating panel as the dressing surface, and it is desirable that the appearance of the elevator operating panel is changeable according to the customer's (buyer's) request (liking).

However, in above conventional elevator operating panel, the faceplate is formed of a single metal plate. Therefore, it is necessary to prepare a variety of the faceplates to fulfill customer's request. This circumstance made such operating panel unsuitable for mass-production thereof and became a factor to raise the cost of the parts.

From this point of view, another conventional elevator operating panel is comprised a dressing surface portion of a faceplate, and the dressing surface portion is adhered to a main body. In this conventional elevator operating panel, it is possible to fulfill a customer's liking by preparing various kind of the dressing surface.

However, in this example, the dressing surface of the faceplate is firmly joined, by adhesive agent, etc., to the main body and is integrated therewith. Therefore, when replacing the faceplate, there arises the problem, similarly to the elevator operating panel of the above-described conventional structure, that the replacing operation becomes complex and troublesome.

The present invention has been made in order to solve the above-described conventional problems and the object of the invention is to provide an elevator operating panel that can be manufactured at a low cost and that can make the appearance thereof changeable according to the customer's liking and that enables the replacing operation for replacing the faceplate to be performed in a very simple and convenient way.

### DISCLOSURE OF THE INVENTION

To attain the above object, there is provided an elevator operating panel being installed at an elevator hall, or within a cab, of an elevator, comprising: an accommodation box having an opening; a switch device disposed within the accommodation box and having an operating portion; a base member that fixes thereto and supports the switch devices and is integrally assembled to the accommodation box; and a dressing member having first opening that allows the operating portion of the switch device and is removably attached to the base member to cover a part of the surface of the base member, wherein the base member and the dressing member close the opening of the accommodation box.

In this elevator operating panel, the faceplate is comprised of the base member and the dressing member for closing the surface of the base member. Switch devices operated by passenger, etc. are fixed to and supported by the base member. Accordingly, it is possible to change an appearance of the faceplate by replacing the dressing member adequately with a lot of dressing members being prepared previously. Also, in a case where the dressing member has been clawed by, for example, passengers' mischief or the like, there is no need to detach the switches from the base member, but only to replace the dressing member with a new dressing member. In addition, since this dressing member is detachably mounted on the base member, above-replacing operation is very simple and convenient by comparison with conventional dressing member replacing operation.

### BRIEF DESCRIPTION OF THE DRAWINGS

FIG. 1 is a view illustrating a hall operating panel that is installed on a landing jamb of an elevator;

FIG. 2 is a longitudinal sectional view illustrating the hall operating panel to which the present invention is applied;

FIG. 3 is an exploded perspective view of the hall operating panel;

FIG. 4 is a view illustrating a cab operating panel that is installed on a return panel within a cab; and

FIG. 5 is an exploded perspective view of the operating panel to which the present invention is applied.

### BEST MODE FOR CARRYING OUT THE INVENTION

An embodiment of the present invention will hereafter be explained in detail with reference to the drawings.

### First Embodiment

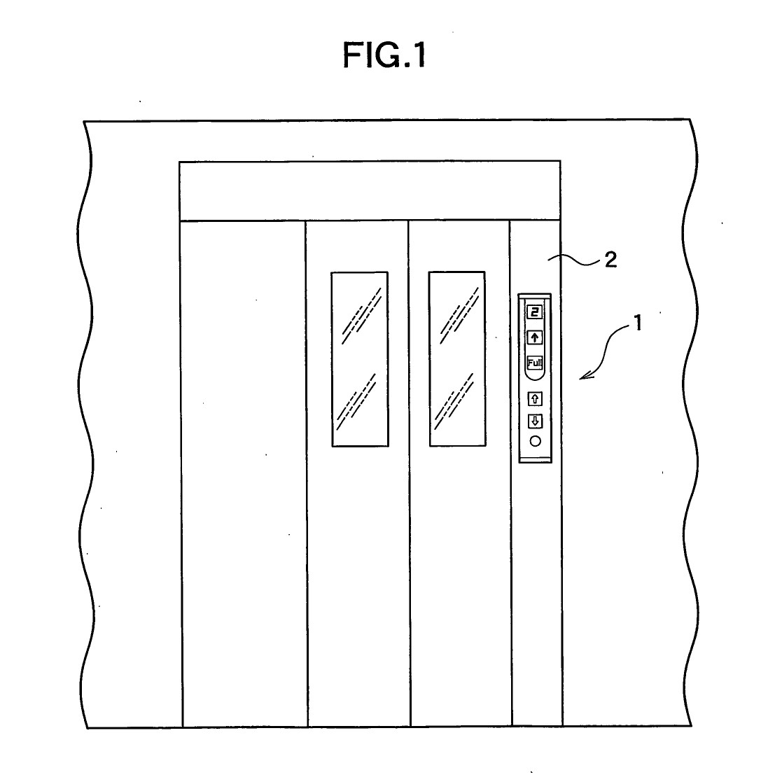

A hall operating panel 1, as illustrated in FIG. 1, is installed on one side of a jamb 2 that surrounds the door at the entrance/exit of the elevator, and the operating panel 1 is utilized when a passenger operates such as a hall call.

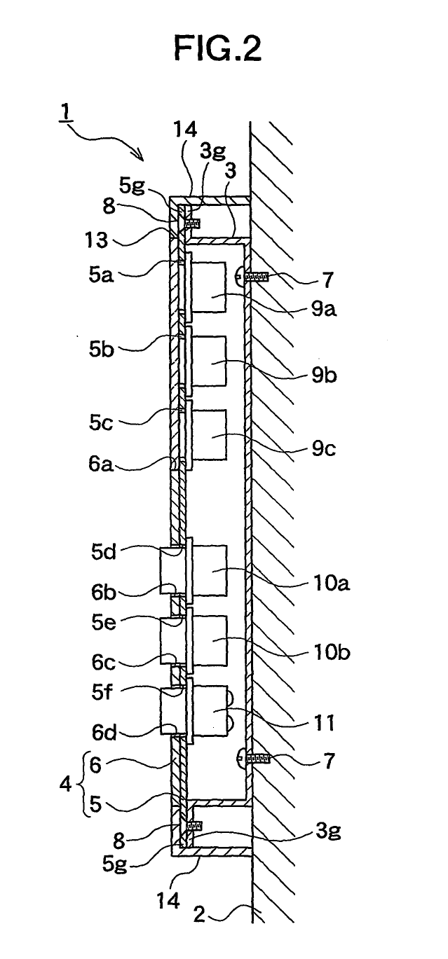

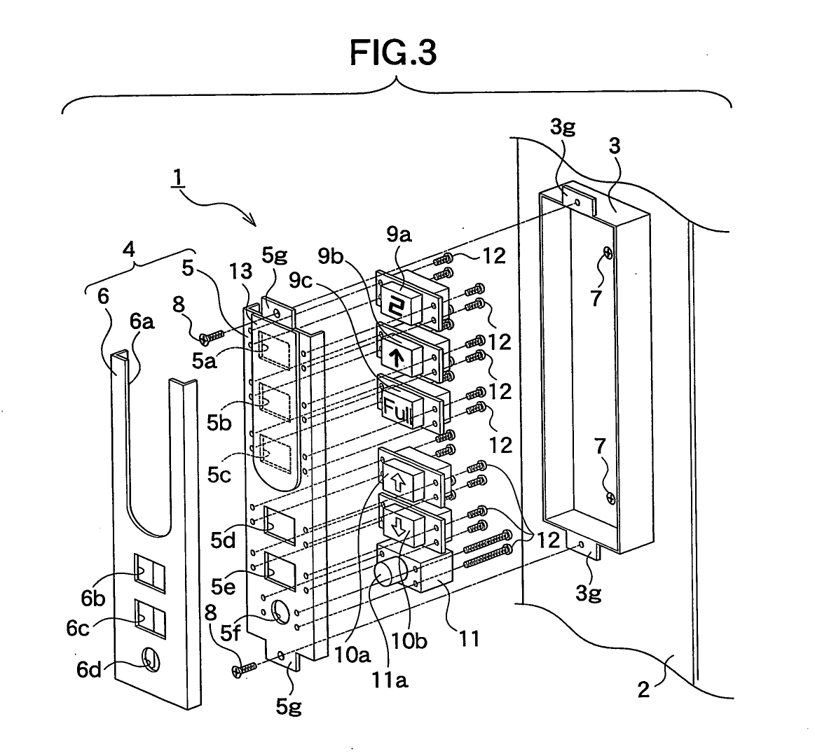

As illustrated in FIG. 2, an accommodation box 3 and a faceplate 4 are assembled integrally with each other. The operating panel 1 is attached to the jamb 2 in a state where an opening portion of the accommodation box 3 is closed by the faceplate 4. In addition, as illustrated in FIG. 3, the faceplate 4 is comprised of a base member 5 and a dressing member 6, wherein the dressing member 6 is removably attached to the base member 5.

The accommodation box 3 is formed by, for example, a metal plate which is bent and formed into a box-shaped, and its bottom surface portion abuts on a surface of the jamb 2 and is fixed to a prescribed position of the jamb 2. In addition, a tapping screws 7 is inserted through the bottom surface of the accommodation box, and the accommodation box 3 is bonded to the jamb 2.

The base member 5 of the faceplate 4 is formed by, for example, a metal plate which is bent and formed into a lid-shaped, the cross section of which has an approximately U-shaped in cross section, and the dimension of which is somewhat greater than the outside dimension of the accommodation box 3. The base member 5 is fitted to the accommodation box 3 from an obverse side thereof to close the opening portion thereof. Fastening pieces 5g, 3g that connect these both members 3, 5 to each other are protruded from the respective both end portions in the longitudinal direction of the both members 3, 5. Tapping screws 8 fasten the fastening pieces 3g, 5g in the state where the fastening pieces 3g, 5g are superposed one upon the other, and the base member 5 is fixed to the accommodation box 3. Incidentally, a portion where the fastening pieces 3a, 5g and accommodation box 3 are superposed one upon the other is retained by a blind frames 14 fixed to the jamb 2, and the blind frame 14 covers the obverse surface sides of the fastening pieces 3g, 5g (see FIG. 3).

Six attaching opening 5a, 5b, 5c, 5d, 5e, and 5f are provided on the base member 5. Various kinds of devices being installed in the hall operating panel 1, concretely three indicators 9a, 9b, and 9c, two switch devices 10a, 10b, and a key switch 11 are attached to the attaching holes accordingly. In addition, the attaching openings pass through the base member 5, and the dimension of attaching openings are corresponds to the dimension of the corresponding switches accordingly.

The three indicators 9a, 9b, and 9c are comprised of display devices for displaying the status of the elevator. For example, the indicator 9a displays the current position of the cab by an illuminated floor number; the indicator 9b displays of the moving direction of the cab by an illuminated arrow; and the indicator 9c displays illuminated control-information such as “FULL”, “MOVE (GO)”, etc. Display parts of the indicators 9a, 9b, and 9c respectively inserted from the reverse-surface side of the base member 5 into the corresponding attaching openings 5a, 5b, and 5c, and attached to the reverse-surface side of the base member 5 by means of tapping screws 12, whereby the indicators are fixed to and supported by the base member 5.

A semi-transparent plate 13 for preventing light from entering the display parts of the indicators 9a, 9b, and 9c is bonded by, for example, an adhesive agent to a position of the base member 5 where the attaching openings 5a, 5b, and 5c are formed.

Covering the indicators 9a, 9b, and 9c by the plate 13, the displayed information on the indicators 9a, 9b, and 9c becomes easy to see. Furthermore, bonding the plate 13 to the obverse-surface side of the base plate 5 by an adhesive agent, it is easily position the dressing member 6 onto the obverse-surface side of the base member 5. Thus, as illustrated in FIG. 3, an opening 6a is provided in the dressing member 6 to engage with the plate 13 with no clearance existing in therebetween. Incidentally, the configuration of the plate 13 and the configuration of the opening 6a may be of any type if the both can be interfitted with each other.

The two switch devices 10a, 10b is used for a passenger operating such as a hall call. For example, the switch device 10a is used as an up-floor button while, on the other hand, the switch device 10ob is used as a down-floor button. And, operating portions are respectively fitted from the reverse-surface side of the base member 5 into the attaching openings 5d, 5e, the switch devices 10a, 10b are attached to the reverse-surface side of the base member 5 by the tapping screws 12. Incidentally, each of these switches 10a, 10b may be constructed of an electrostatic type switch or a push-button type switch.

The key switch 11 is a switch controlled by a manager or a maintenance engineer of the elevator with a single-purpose key (not illustrated). And, a forward end portion of a cylinder 11a of the key switch 11 allowing the key to be inserted thereinto is inserted from the reverse-surface side of the base member 5 into the attaching opening 5f, the key switch 11 is attached to the reverse-surface side of the base member 5 by the tapping screws 12 and is thereby fixed to and supported by the base member 5.

As described above, in the hall operating panel 1 to which the present invention has been applied, all of the various kinds of switches being built in the hall operating panel 1 are attached to the base member 5 of the faceplate 4 and are fixed to and supported by that base member 5. And, the dressing member 6 is detachably attached onto the obverse-surface side of the base member 5, and it is thereby arranged that the dressing member 6 protects the base member 5 and enhances the appearance of the elevator operating panel 1.

Incidentally, an incandescent lamp, a light-emitting diode (LED) that emits red, blue, green, or white, color light, a fluorescent lamp (cold-cathode tube, etc.), an organic EL, etc are used for a light source of the various kinds of indicators 9a, 9b, and 9c and switch devices 10a, 10b. However, when considering the use within a closed space such as the hall operating panel 1, the illumination device that uses an LED, or a cold-cathode tube, which is small in size and long in service life is particularly effective.

The dressing member 6 is formed by, for example, a metal plate which is bent to form an U-shaped in cross section, and the dimension of the dressing member corresponds to the base member 5. And, a dressing film is pasted to the obverse surface of the dressing member 6, and thereby the dressing surface thereof is formed. By preparing the various kinds of dressing films having the color and design, the customer (buyer) fulfill their request (liking). Further, attaching the dressing film selected by the customer on the dressing surface, it is possible to customize the dressing member 6.

The opening 6a corresponding to the plate 13 being bonded to the obverse surface side of the base member 5, openings 6b, 6c corresponding to the display parts of the switch devices 10a, 10b that are fixed to and supported by the base member 5, and opening window 6d corresponding to the forward end portion of the cylinder 11a of the key switch 11 that is fixed to and supported by the base member 5 are provided in the dressing member 6. Every one of these openings 6a, 6b, 6c, and 6d passes through the dressing member 6 in the thickness direction thereof. In the way that the dressing member 6 is superposed on the obverse-surface side of the base member 5 in a state where the plate 13, the display parts of the switch devices 10a, 10b, and the forward end portion of the cylinder 11a of the key switch 11 are exposed to the outside from the openings 6a, 6b, 6c, and 6d, the dressing member 6 is fitted onto the obverse-surface side of the base member 5. By being fitted the dressing member 6 onto the base member 5, the dressing member 6 constitutes the faceplate 4 wherein it is integrated with this base member 5. Accordingly, the dressing member 6 can easily be detached from the base member 5.

In the above-constructed hall operating panel 1, the faceplate 4 is made into a dual structure wherein the dressing member 6 is superposed on the obverse-surface side of the base member 5. Therefore, even when the faceplate 4 is clawed by, for example, passengers' mischief, only the dressing member 6 is clawed. And, since the dressing member 6 is removably attached to the base member 5 and can easily be detached from the base member 5, the operation of replacing the clawed dressing member 6 with a new one can be performed in a very simple and convenient way.

When replacing the dressing member 6, the dressing member 6 that has been fitted on the base member 5 is detached from it. At this time, since the indicators 9a, 9b, and 9c, switch devices 10a, 10b, key switch 11, etc. being attached in the hall operating panel 1 are all attached to the base member 5 and fixed to and supported by this base member 5. Hence, even in the state of the dressing member 6 is detached, it doesn't happen that those various kinds of devices fall off. Accordingly, only by, after detaching the clawed dressing member 6 from the base member 5, fitting a new dressing member 6 onto the base member 5, the replacing operation for the dressing member 6 becomes complete. Namely, this operation is very simple and convenient.

In the conventional operating panel, the various kinds of devices being attached in the operating panel are fixed and supported by the faceplate that consists of a single piece of member. Therefore, when replacing the faceplate with a new one, it is necessary to newly attach those devices again to the new faceplate. This structure became a factor to make the faceplate-replacing operation complex and troublesome. In contrast to this, in the hall operating panel 1 to which the present invention has been applied, the faceplate 4 has a dual structure of its being constructed of the base plate 5 and the dressing member 6. And, in the dual structure, it is arranged that the surface of the base member 5 having the various kinds of devices fixed thereto and supported thereby be covered by the dressing member 6. And, the dressing member 6 is detachably attached to the base member 5. For these reasons, it is possible to replace only the dressing member 6, with simple and convenient operations without newly attaching the various kinds of devices, etc.

Also, in the hall operating panel 1 to which the present invention has been applied, it is possible to select and use, as the dressing film of the dressing member 6, the one that fulfills the customer's request and liking. As a result of this, it is possible to customize the appearance of the dressing member 6 into a way of its conforming to the customer's liking. Therefore, it is possible to meet a lot of demands that come up from a lot of customers.

Also, the present invention can also effectively be applied when performing renewal of an existing hall operating panel. And if renewing an existing hall operating panel through the use of the present invention, then it is thereafter possible to perform the operation of replacing the dressing member with a new one in a very simple and convenient way.

### Second Embodiment

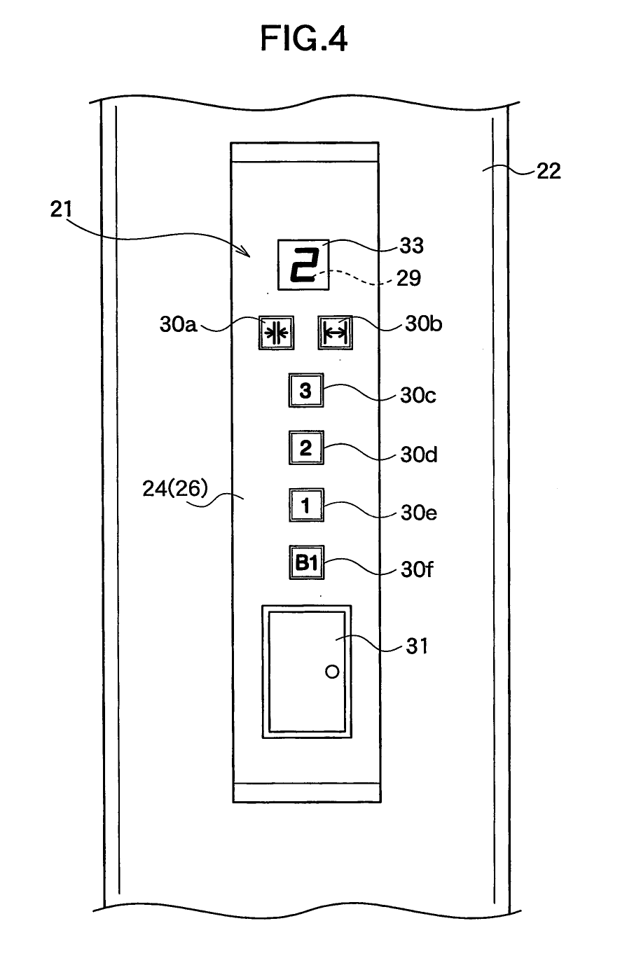

This embodiment is the one wherein the present invention is applied to a cab operating panel that is installed within the cab of an elevator. A cab operating panel 2 1, as illustrated in FIG. 4, is installed on a return panel 22 located on a sideward portion of a cab door, and the cab operating panel is utilized when a passenger within the cab performs his operation such as a cab call.

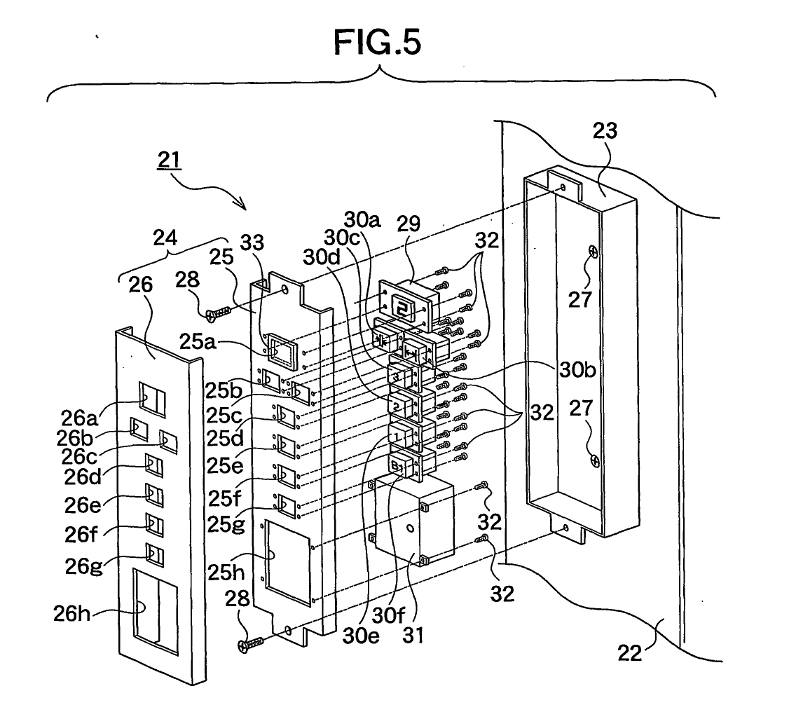

The cab operating panel 21 is the same, in the basic structure, as the hall operating panel 1 of the above-described first embodiment, but is different, in the kind of the devices built therein, from the hall operating panel 1. Namely, this cab operating panel 21 has an outstanding feature in that, as illustrated in FIG. 5, the cab operating panel 21 is installed on the return panel 22 in a state where an opening portion of an accommodation box 23 is closed by a faceplate 24; and the faceplate 24 is comprised of a base member 25 and a dressing member 26 are superposed one upon the other; and the dressing member 26 is detachably attached to the base member 25.

The accommodation box 23, similarly to the accommodation box 3 of the above-described hall operating panel 1, is formed into a box shaped, and the accommodation box 23 is firmly bonded to the return panel 22 by tapping screws 27. Also, the base member 25 of the faceplate 24 is formed into a lid-like shaped having a substantially U-shaped in cross section, and the base member 25 is fitted to the accommodation box 23 from the obverse-surface side thereof and is firmly bonded to the accommodation box 23 using tapping screws 28.

Attaching openings 25a, 25b, 25c, 25d, 25e, 25f, 25g, and 25h for attaching to the base member 25 various kinds of devices built in the cab operating panel 21, for example, an indicator 29 that displays the current position of the cab by an illuminated floor number, switch devices 30a, 30b that instruct opening and closing of the cab door, switch devices 30c, 30d, 30e, and 30f that designate a passenger's floor of destination, a switch box 31 that has provided therein various kinds of switches for adjusting the environment within the cab, etc. are penetrate though the base member 25 in the thickness direction thereof. The dimension of each attaching openings correspond to that of each corresponding one of those devices accordingly.

Display part of the indicator 29 is fitted from the reverse-surface side of the base member 25 into the attaching opening 25a and is attached to the reverse-surface side of the base member 25 by using tapping screws 32, and the indicator 29 is fixed to and supported by the base member 25. Incidentally, to the obverse-surface side of the base member 25, there is bonded a display part surface plate 33 at the position where the attaching opening 25a is formed. By covering the display part of the indicator 29 by the display part surface plate 33, the information being illuminated on the display part is easy to see. Also, incidentally, as a result of the display part surface plate 33 is bonded to the obverse-surface side of the base member 25, it is easily position the dressing member 26 to the obverse-surface side of the base member 25.

Also, operation portions of the switch devices 30a, 30b, 30c, 30d, 30e, and 30f are respectively fitted from the reverse-surface side of the base member 25 into the attaching openings 25b, 25c, 25d, 25e, 25f, and 25g and are attached to the reverse-surface side of the base member 25 by using tapping screws 32, and those switch devices are fixed to and supported by the base member 25.

Also, a front side of the switch box 31 where a door thereof is provided is inserted from the reverse-surface side of the base member 25 into the attaching opening 25h and, the switch box 31 is attached to the reverse-surface side of the base member 25 using the tapping screws 32 and is fixed to and supported by the base member 25.

As described above, in the cab operating panel 21 to which the present invention is applied, similarly to the hall operating panel 1 previously stated according to the first embodiment, it is arranged that every one of the various kinds of devices that are built in the cab operating panel 21 be attached to the base member 25 of the faceplate 24 and fixed to and supported by this base member 25. And, to the obverse-surface side of the base member 25, there is detachably attached the dressing member 26, thereby the protection of the base member 25 and the enhancement of the appearance of the operating panel 21 are achieved using that dressing member 26.

Incidentally, an incandescent lamp, a light-emitting diode (LED) that emits red, blue, green, or white, color light, a fluorescent lamp (cold-cathode tube, etc.), an organic EL, etc are used for a light source of the various kinds of indicators 29 and switch devices 30a, 30b, 30c, 30d, 30e, and 30f. However, when considering the use within a closed space such as that in the operating panel 21, the illumination device that uses an LED, or a cold-cathode tube, which is small in size and long in service life is particularly effective.

Same as the dressing member 6 of the first embodiment, the dressing member 26 is formed by, for example, a metal plate which is bent to form an U-shaped in cross section, and the dimension of the dressing member corresponds to the base member 5. And, a dressing film is pasted to the obverse surface of the dressing member 26, and thereby the dressing surface thereof is formed. By preparing the various kinds of dressing films having the color and design, the customer (buyer) fulfill their request (liking). Further, attaching the dressing film selected by the customer on the dressing surface, it is possible to customize the dressing member 26.

The opening 26a corresponding to the plate 33 being bonded to the obverse surface side of the base member 25, openings 26b, 26c, 26d, 26e, 26f, and 26g corresponding to display parts of the switch devices 30a, 30b, 30c, 30d, 30e, and 30f that are fixed to and supported by the base member 25, and an opening 26h corresponding to the forward end portion of the door of the switch box 31 that is fixed to and supported by the base member 5 are provided in the dressing member 6. Every one of these openings 26a, 26b, 26c, 26d, 26e, 26f, and 26g passes through the dressing member 26 in the thickness direction thereof. In the way that the dressing member 26 is superposed on the obverse-surface side of the base member 25 in a state where the display part surface plate 33, the display parts of the switch devices 30a, 30b, 30c, 30d, 30e, and 30f, and the doors of the switch box 31 are exposed to the outside from the openings 26a, 26b, 26c, 26d, 26e, 26f, and 26g, the dressing member 6 is fitted onto that obverse-surface side of the base member 25. By being fitted the dressing member 26 onto the base member 25, the dressing member 26 constitutes the faceplate 24 wherein it is integrated with this base member 25. Accordingly, the dressing member 26 can easily be detached from the base member 25.

In the above-constructed cab operating panel 21, similarly to the hall operating panel 1 of the above-described first embodiment, only the dressing member 26 is clawed by, for example, passengers' mischief. And, since the dressing member 26 is removably attached to the base member 25 and is thereby arranged to be able to be easily detached from this base member 25, the operation of replacing the clawed dressing member 26 with a new one can be performed in a very simple and convenient way.

Also, in the cab operating panel 21 to which the present invention has been applied, it is possible to select and use, as the dressing film of the dressing member 26, the one that fulfills the customer's request and liking. As a result of this, it is possible to customize the appearance of the dressing member 26 accordingly to the customer's liking. Therefore, it is possible to meet a lot of demands that come up from a lot of customers.

Also, the present invention can also effectively be applied when performing renewal of an existing cab operating panel. And if renewing an existing cab operating panel through the use of the present invention, it is possible to perform the operation of replacing the dressing member 26 with a new one in a very simple and convenient way as stated above.

### INDUSTRIAL APPLICABILITY

According to the elevator operating panel according to the present invention, the faceplate is constructed of the base member and the dressing member for closing the obverse surface thereof. And the switch devices operated by passengers, etc. are fixed to and supported by the base member. In addition, the dressing member is removably attached to the base member. Therefore, in a case where the dressing member has been clawed by, for example, passenger's mischief or the like and the replacement thereof has become needed, the relevant replacing operation can be performed in a very simple and convenient way.

Also, in this elevator operating panel, by preparing many kinds of dressing members as the dressing member thereof in advance and selecting the dressing member attached to the base member in conformity with the customer's request, the appearance of that operating panel can be customized into the one that fits the customer's liking.

1. An elevator operating panel which installed at an elevator hall, or within a cab, of an elevator, comprising:
an accommodation box (3, 23) having an opening;
a switch device (10a, 10b, 30a, 30b, 30c, 30d, 30e, 30f) being disposed within the accommodation box and having an operating portion;
a base member (5, 25) that fixes thereto and supports the switch device and is integrally assembled to the accommodation box; and
a dressing member (6, 26) having first opening (6a, 6b, 26b, 26c, 26d, 26e, 26f, 26g) allowing the operating portion of the switch device and is removably attached to the base member to cover a part of the surface of the base member,
wherein the base member and the dressing member close the opening of the accommodation box.

2. The elevator operating panel according to claim 1, wherein the switch device is fixed to and supported by the base member, in a state where the dressing member is attached to the base member, the operating portion& projects from the dressing member to outside the dressing member via the first opening.

3. The elevator operating panel according to claim 1, wherein a display devices (9a, 9b, 9c, 29) having a display portion for displaying the status of the elevator is fixed to and supported by the base member, and the dressing member comprises a second opening (6a, 26a) for allowing the display portion& of the display devices to be exposed to outside the dressing member.

4. The elevator operating panel according to claim 3, wherein the second opening is provided on an upper side of the dressing member.

5. The elevator operating panel according to claim 3, wherein the second opening is formed into a substantially U-shaped in cross section.

6. The elevator operating panel according to claim 3, wherein the display device is fixed to and supported by the base member in a state where the dressing member is attached to the base member, the display portion does not project from the dressing member to outside of the dressing member.

7. The elevator operating panel according to claim 6, wherein a semi-transparent surface plate (13, 33) is adhered to a front side surface of the display device where the display device is supported by the base member, and wherein the semi-transparent surface plate protrudes toward the dressing member.

8. The elevator operating panel according to claim 7, wherein the surface plate is arranged on the same plane as the dressing member when the dressing member is attached to the base member.

9. The elevator operating panel according to claim 1, further comprises a key switch (11) which is fixed to the base member,
and a third opening (6d) which is provided with the dressing member and allows an operation portion of the key switch to be exposed to outside the dressing member.

10. The elevator operating panel according to claim 1, further comprises a switch box (31) which is fixed to the base member and having at least a switch for adjusting the environment within a relevant cab, and a fourth opening (26h) for enabling a door of the switch box open and close from outside the dressing member is provided in the dressing member.
